(19) United States
(12) Patent Application Publication
(10) Pub. No.: US 2018/0027220 A1
(43) Pub. Date: Jan. 25, 2018

(54) VIRTUAL SPACE CALIBRATION

(71) Applicant: ENT. SERVICES DEVELOPMENT CORPORATION LP, Tysons, VA (US)

(72) Inventors: Joshua HAILPERN, Sunnyvale, CA (US); William J. ALLEN, Corvallis, OR (US); James C. COOPER, Bloomington, IN (US); Kieran MCCORRY, Belfast Armagh (GB)

(73) Assignee: ENT. SERVICES DEVELOPMENT CORPORATION LP, Tysons, VA (US)

(21) Appl. No.: 15/547,574

(22) PCT Filed: Jan. 30, 2015
(86) PCT No.: PCT/US2015/013733

§ 371 Date: Jul. 31, 2017

(51) Int. Cl. H04N 9/31

(52) U.S. Cl. CPC H04N 9/3194; H04N 9/3147; H04M 3/567

(57) ABSTRACT

Examples associated with virtual space calibration are disclosed. One example includes calibrating a first physical space to a virtual space in response to a first signal received from a first device in the first physical space. A second physical space is calibrated to the virtual space in response to a second signal received from a second device in the second physical space. The second device is controlled to project, into the second physical space, a representation of a first artifact from the first physical space. The representation of the first artifact is projected into the second physical space based on the calibration of the first physical space to the virtual space, and based on the calibration of the second physical space to the virtual space.

### BACKGROUND

There are two main ways that meetings take place, depending primarily on whether there is a single, appropriate space that is accessible to all parties. If such a space is available, the meeting may be held in that space. If such a space is not available, (e.g., because all available spaces are too small to fit all parties, the parties are spread across great distances), then some form of digital collaboration tools system may be used. These teleconferencing systems work by transmitting, for example, video, slides, audio, and so forth, to other locations simultaneously so that participants can engage in synchronous communication.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates example rooms, people, and artifacts on which example systems and methods, and equivalents, may operate.

FIG. 2 illustrates a flowchart of example operations associated with virtual space calibration.

FIG. 3 illustrates another flowchart of example operations associated with virtual space calibration.

FIG. 4 illustrates an example system associated with virtual space calibration.

FIG. 5 illustrates another example flowchart of example operations associated with virtual space calibration.

FIG. 6 illustrate other flowchart of example operations associated with virtual space calibration.

FIG. 7 illustrates an example computing device in which example systems and methods, and equivalents, may operate.

### DETAILED DESCRIPTION

Systems, methods, and equivalents associated with virtual space calibration are described. Virtual space calibration may be a process that facilitates synchronous communication between people in different spaces using techniques described herein. When two groups of people in different rooms seek to engage in synchronous communication, the rooms may be calibrated to one another and/or a virtual space that is used to facilitate linking the two rooms. Calibrating the rooms to one another or the virtual space may include orienting the rooms to exploit usable space in the rooms, and may also include identifying surfaces in the rooms suitable for collaboration or devices that can be controlled to, for example, display a resource (e.g., TV, laptop, projector, smart board). Consequently, calibrating the rooms may facilitate capturing content (e.g., images, video, audio) from one room, and transmitting and projecting the content into other rooms in a manner that preserves relationships between items and people in the different rooms during periods of synchronous communication.

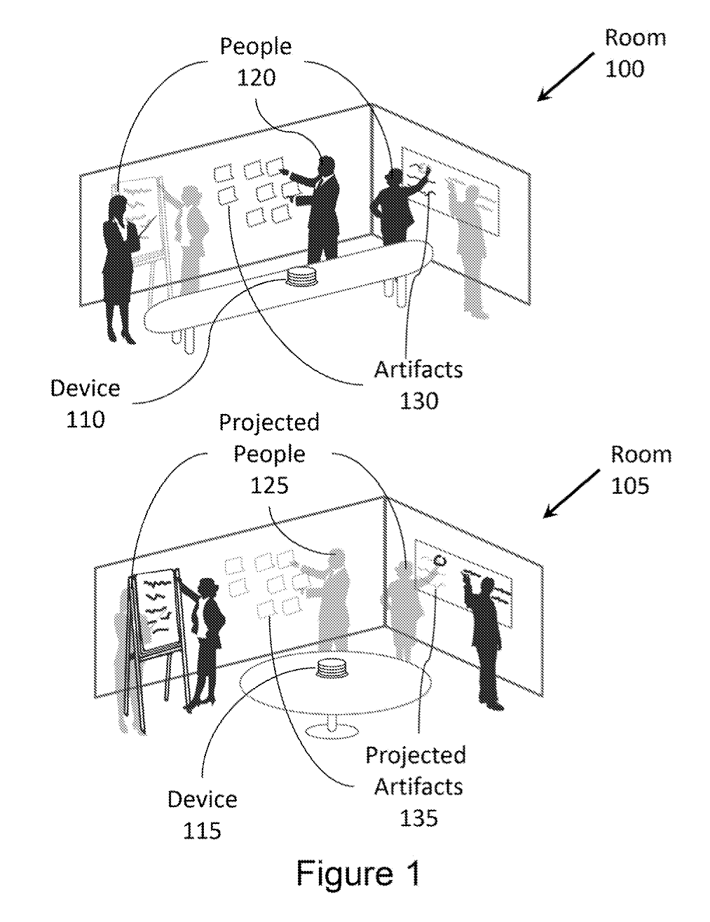

FIG. 1 illustrates example rooms, people, and artifacts on which example systems and methods, and equivalents, may operate. It should be appreciated that the items depicted in FIG. 1 are illustrative examples and many different features and implementations are possible.

FIG. 1 illustrates two rooms 100 and 105. These rooms may be, for example, conference rooms in different locations. Room 100 contains a device 110, and room 105 contains a device 115. Though FIG. 1 illustrates one example manner of operation of devices 110 and 115 relating to a synchronous meeting, other possible uses of devices 110 and 115 (e.g., subsequent meetings, individual reviews) are also possible. By way of illustration, devices 110 or 115 could be personal computers (e.g., laptops) controlling projection and/or capture equipment in a room. A computer could also be used to display a 2D or 3D representation of a virtual space to an individual using the computer who doesn't have access to a physical space suitable for projection of representations of digital objects.

Devices 110 and 115 may contain equipment for capturing (e.g., video cameras, high-resolution still image cameras, microphones, motion sensors) actions of people 120 in rooms 100 and 105 as the people 120 interact with artifacts 130. Artifacts 130 may include, for example, physical objects and digital content elements. Physical objects may include, for example, note cards, flip charts, models, writing on a whiteboard, and other objects physically present in rooms 100 and 105. Digital content elements may include items projected or displayed in rooms 100 and 105 (e.g., presentation slides, a television screen). In some instances it may also be appropriate to treat people 120 as artifacts. Treating people 120 as artifacts may facilitate capturing actions and interactions of people 120 with other people 120 and with artifacts 130.

Devices 10 and 115 may also contain equipment for projecting (e.g., projectors) or otherwise displaying images of projected people 125 and projected digital objects 135 into rooms 100 and 105. The digital objects 135 and people 125 projected into rooms 100 and 105 may be, for example, stored as data on one or more of device 110 and device 115 in association with a virtual space. Projecting digital objects 135 and people 125 into rooms 100 and 105 may facilitate review and/or interaction with the projected people 125 and the projected digital objects 135. Thus, the projected people 125 and projected digital objects may be projected based on previous recording, simultaneous recording (e.g., a projection of a person or artifact being captured in real time), a combination of the above, and so forth.

As used herein, a virtual space may be a representation of a room that is maintained as data in a data store (e.g., locally within device 110 or device 115, at a server remote from device 110 and device 115). Several digital objects may be associated with each virtual space. Each digital object may be associated with an artifact that at one point existed in a physical space that was then digitized (e.g., by capturing an artifact from a physical space, creating a digital object from a web page or video). An artifact could be, for example, an individual stroke of a pen on a white board, a photograph, a person, and so forth, and many different granularities of capture and digitization may be possible. Maintaining individual digital objects separately from one another may facilitate review and manipulation of digital objects on an individual basis. By way of comparison, a video camera that records all content in front of it without distinguishing between different persons and/or artifacts in the field of view of the camera may not be able to facilitate review of items recorded at differing times, or interacting with objects in a video after the video has been recorded. By storing digital objects in the virtual space and capturing state changes of the artifacts and/or digital objects, and interactions with the artifacts and/or digital objects, review of two different digital objects at two points in time may be achieved.

Each virtual space in the data store may be associated with a given project, topic, product, and so forth. Thus, when a team working on, for example, a given project associated with a virtual space concludes a meeting and later reconvenes, information associated with the virtual space from the concluded meeting may be quickly recovered by loading the virtual space and projecting digital objects 135 into the new meeting location. By way of illustration, if, during a first meeting, text was written on a white board and a set of post it notes were organized on a different wall, digital objects describing the text and post it notes may be stored to corresponding locations of a virtual space. If the virtual space is loaded at a later time, representations of the digital objects may be projected or displayed, effectively recovering a state of the previous room, even if the physical room has changed.

Similarly, if a virtual space is loaded simultaneously at two or more different locations, the locations may be calibrated to that virtual space, and then artifacts 130 from each location may be projected into other locations as projected artifacts 135, and people 120 may be projected into other locations as projected people 125. The locations at which people and artifacts are projected may be based on how different locations are calibrated to the virtual space based on attributes of individual locations and on attributes of the virtual space.

To facilitate preservation of these spatial relationships, it may be important for devices 110 and 115 to calibrate rooms 100 and 105 to the virtual space. In some examples, this may mean orienting the virtual space to rooms 100 and 105 so that representations of digital objects projected back into rooms 100 and 105 are projected onto suitable locations within respective rooms. By way of illustration, it may be difficult for people 120 in room 100 to view and/or interact with representations of digital objects 135 projected onto windows. Similarly, it may be preferable to select projection locations on walls that are largely free from obstructions and/or decorations to ensure representations of digital objects are projected clearly and onto suitable surfaces within room 100 (e.g., blank white walls). Calibrating rooms 100 and 105 may also facilitate adjusting for light sources and/or ambient light, manipulating projected digital objects 135 and/or projected people 125 based on colors of surfaces onto which they will be projected, and so forth.

Various techniques may be used to calibrate rooms 100 and 105 to the virtual space. For example, devices 110 and 115 may contain various sensors (e.g., infrared sensors for distance mapping), logics and so forth for identifying attributes of rooms 100 and 105 so that they can be calibrated to the virtual space.

In various examples, devices 110 and 115 may contain memory for storing information associated with digital objects generated from artifacts 130, and the virtual space. Devices 110 and 115 may also contain communication equipment (e.g., network card, Bluetooth functionality) to facilitate transmitting information associated with digital objects, and so forth. As mentioned above, data describing the virtual space and digital objects may be stored in a memory local to one of device 110 and 115, at a remote server, or a combination of the above.

To facilitate reconstruction of artifacts into the rooms 100 and 105 after the rooms have been calibrated to the virtual space, digital objects associated with a given virtual space may be given “locations” within the virtual space. These locations within the virtual space may facilitate preservation of, for example, relative spatial relationships between artifacts, walls, edges, and people over time. The locations given to digital objects in the virtual space may be based on how rooms 100 and 105 are calibrated to the virtual space. Additionally, locations in rooms 100 and 105 at which representations of digital objects are projected may also depend on this calibration. Here, calibration of rooms 100 and 105 to the virtual space is performed when devices 110 and 115 respectively first detect they have been placed into a new room or are otherwise activated. Among other things, the calibration may facilitate orienting rooms 100 and 105 to the virtual space. This may facilitate preserving relative spatial relationships between digital objects when they are projected into rooms 100 and 105.

For example, room 100 may have windows on a north facing wall, while room 105 may have windows on a south facing wall. Consequently, devices 110 and 115 may calibrate rooms 100 and 105 respectively so that digital objects are projected at relative locations using the three non-windowed walls in each room. This may be achieved by mapping the north facing wall of room 100 and the south facing wall of 105 to the same wall in the virtual space. Alternatively, walls in the second room could be rotated by one wall, keeping wall order the same, re-spacing artifacts to avoid the windows in one or both of room 100 and room 105, and so forth. Consequently, during simultaneous access of a virtual space, room 100 and 105 may have different presentations of digital objects from the virtual space into the rooms while preserving data storage, relative positioning, and so forth.

In FIG. 1, devices 110 and 115 are illustrated as seated atop respective tables within rooms 100 and 105. In this example, devices 110 and 115 may be mobile units that can be transported to different rooms as necessary and seated atop tables. This may allow essentially any space to be converted into a meeting room to handle relocations, space availability issues, and so forth. In another example, devices 110 and 115 may be built into the conference room allowing the creation of designated collaboration rooms. Though designated collaboration rooms may create a limited resource that is competed over by various projects within an organization, there may be reasons for using designated collaboration rooms over mobile units. For example, a room built to house a device may be able to be designed to better accommodate recording and/or projection equipment. For example, projectors hung from the ceiling may create larger projections than one placed on a surface (e.g., a table) within a room. Further, for the purpose of this application, the term “projecting”, as used with respect to a digital object, may include displaying the digital object, as an artifact projected onto a segment of a wall, may be functionally equivalent to an artifact displayed on a monitor or screen on a wall instead. Additionally, a designated space may be designed so that surfaces within the room are more amenable to preserving spatial relationships of artifacts within a digital representation of the room.

Between rooms 100 and 105, five people 120 are having a meeting discussing a topic (e.g., a project, a problem, a product). Three of the people 120 are in room 100, and two of the people 120 are in room 105. Additionally, the people 120 may be discussing various artifacts 130 throughout the room. In FIG. 1, items (e.g., device 110, artifacts 130) and people 120 actually in a room are indicated using black, and items projected into a room (e.g., projected people 125, projected artifacts 135) are indicated in gray.

In this example, the artifacts in room 100 include notes attached to a wall and a dry-erase board. Artifacts in room 105 include a flip-chart on an easel and a dry-erase board. Though several textual artifacts are illustrated, digital artifacts (e.g., projected slides), people (e.g., people 120), and physical objects (e.g., a product demo) could also be treated as artifacts by devices 110 and 115.

Using capture equipment, device 110 may capture interactions of people 120 with artifacts 130 in room 100. These interactions may include modifying artifacts 130, creating artifacts 130, removing artifacts 130, discussing artifacts 130, and so forth. These interactions may then be transmitted from device 110 to device 115 (e.g., over the Internet). Device 115 may then generate projections of the people 120 in room 100 as projected people 125 in room 105. Device 115 may also generate projections of the artifacts 130 in room 100 as projected artifacts 135 in room 105.

By way of illustration, consider the person in room 120 interacting with the notes attached to the wall. In one example, each note may be treated as an individual artifact. If the person interacting with the notes rearranges the notes or modifies a note (e.g., by writing on the note), device 110 may record these interactions and/or modifications and cause these modifications to be transmitted to and projected by device 115 into room 105.

Similarly, device 115 may use capture equipment to capture interactions of people 120 in room 105 with artifacts 130 in room 105, which may be transmitted to and projected by device 110 into room 100.

As discussed above, these features may add additional functionality beyond some meeting room setups involving a set of video recording equipment and either a set of displays (e.g., televisions, monitors) or projectors. Though these meetings in these types of rooms may be recorded and broadcast to other locations, they do not individually track artifacts and/or digital objects over time and preserve state changes. Consequently, such a setup, if recording functionality exists at all, might require replaying everything going on in one of these rooms, without being able to separate and control review of individual artifacts or digital objects. Similarly, preserving a meeting state at the end of a meeting, if certain artifacts need to be preserved, may require maintaining the artifacts individually by removing them from the room and physically storing the artifacts, as opposed to storing the artifacts digitally so that they may be automatically recovered.

The capture and projection of interactions with and state changes of artifacts in room 100 may be facilitated by use of a virtual space and a set of digital objects associated with artifacts 130 in room 100. In one example, the virtual space may be maintained within device 110 and/or device 115. In another example, the virtual space may be maintained in a server in communication with devices 110 and 115. In either case, many virtual spaces may be maintained and each virtual space may be associated with a given project, topic, product, and so forth. Thus, when a team working on, for example, a given project concludes a meeting and later reconvenes, artifacts from the concluded meeting may be quickly recovered by loading the appropriate virtual space and projecting associated artifacts into the new meeting location. Consequently, any given device 110 may, at various times, be associated with different virtual spaces, and associations between a virtual space, a device 110, and a room may or may not be maintained.

As artifacts are interacted with and modified over time, the interactions and attributes may be recorded by devices 110 and 115 and associated with a corresponding digital object. When a representation of the artifact is ultimately projected, the representation projected may be associated with a specific state or interaction so that prior states of the artifact may be reviewed. This may facilitate reviewing discussions relating to the artifact and/or changes made to the artifact over time.

In one example, instead of a physical location, it may be desirable to project the virtual space as a virtual rendering of the virtual space. This virtual rendering may be, for example, a 2D or 3D representation of the virtual space that a person can view using their personal computer. Using a virtual rendering may be desirable when, for example, a person working on a project wants to review modifications to and/or interactions with an artifact without requiring a physical location (e.g., room 100) into which to project an artifact 130. Similarly, a virtual rendering may allow a person to participate in, attend, and/or interact with artifacts in a live meeting without requiring that person to obtain a physical space. In another example, a person may be able to interact with the virtual space projected onto a near-to-eye display (e.g., using virtual reality technologies).

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module (e.g., ASIC), an analog circuit, a digital circuit, a programmed module device, a memory device containing instructions, and so on. Modules may include one or more gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

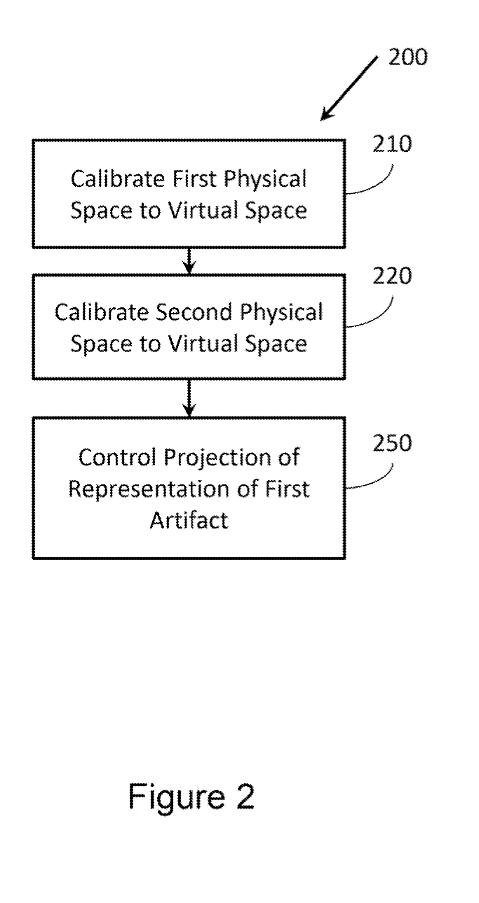

FIG. 2 illustrates an example method 200 associated with virtual space calibration. Method 200 may be embodied on a non-transitory computer-readable medium storing computer-executable instructions. The instructions, when executed by a computer may cause the computer to perform method 200. In other examples, method 200 may exist within logic gates and/or RAM of an application specific integrated circuit.

Method 200 includes calibrating a first physical space at 210. The first physical space may be calibrated to a virtual space. The first physical space may be calibrated to the virtual space in response to a first signal. The first signal may be received from a first device. The first device may be in the first physical space. Calibrating the first physical space to the virtual space may include, for example, orienting the first physical space to the virtual space or mapping portions of the virtual space to the first physical space. These may facilitate preservation of spatial relationships as artifacts from the first physical space are stored as digital objects in the virtual space and as representations of digital objects are projected into the first physical space. Other information may be collected (e.g., lighting, color) regarding the first physical space when calibrating the first physical space to the virtual space.

Method 200 also includes calibrating a second physical space at 220. The second physical space may be calibrated to the virtual space. The second physical space may be calibrated to the virtual space in response to a second signal. The second signal may be received from a second device. The second device may be in the second physical space. Calibrating both the first physical space and the second physical space to the virtual space by the respective devices may facilitate linking the first physical space and the second physical space. While both spaces are linked, synchronous communication between the devices may be possible by projecting artifacts and actions taken by people from one space into the other.

Method 200 also includes controlling the second device to project a representation of a first artifact at 250. The first artifact may be in the first physical space. The representation of the first artifact may be projected into the second physical space based on the calibration of the first physical space to the virtual space. The representation of the first artifact may also be projected into the first physical space based on the calibration of the second physical space to the virtual space. Various techniques may be used to distinguish the first artifact from other artifacts and/or elements of the first physical space (e.g., decorations, walls, people). These techniques may include, for example, seam carving techniques, chroma key techniques, safety box techniques, outline projection techniques, and so forth.

In various examples, the first signal and the second signal may be received by a server remote to the first device and remote to the second device. In these examples, the server may control the second device to project the representation of the first artifact. In other examples, the first signal and the second signal may be received by the first device or the second device. In these examples, one of the first device and the second device may control the second device to project the representation of the first artifact.

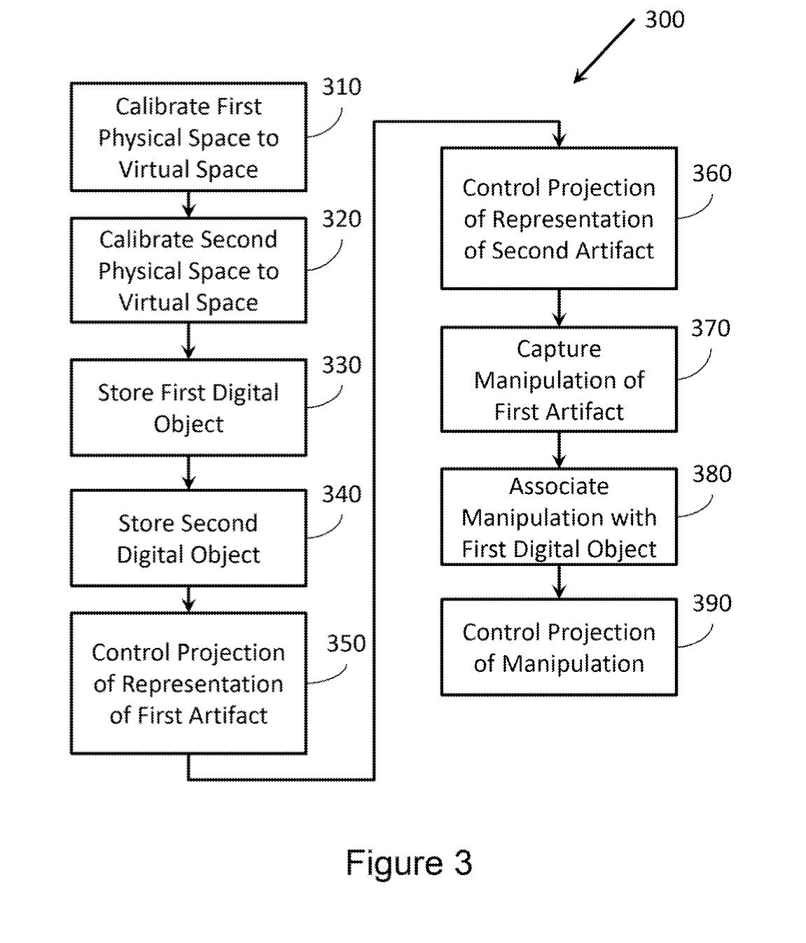

FIG. 3 illustrates a method 300 associated with virtual space calibration. Method 300 includes several actions similar to those described above with reference to method 200 (FIG. 2). For example, method 300 includes calibrating a first physical space to a virtual space at 310, calibrating a second physical space to the virtual space at 320, and controlling projection of a representation of a first artifact at 350.

Method 300 also includes storing a first digital object at 330. The first digital object may be associated with the first artifact. The first digital object may be stored in the virtual space. The representation of the first artifact projected in to the second physical space may be generated based on the first digital object. Consequently, the representation of the first artifact may be generated by transmitting data describing the first digital object to the second device.

Method 300 also includes storing a second digital object at 340. The second digital object may be associated with a second artifact. In this example, the second artifact may be in the first physical space, the second physical space, and so forth. The second digital object may be stored in the virtual space. Storing the second digital object may establish a spatial relationship between the first digital object and the second digital object in the virtual space. Consequently, when the second device projects the representation of the first artifact into the second physical space, the representation may be projected in a manner that preserves the spatial relationship.

In one example, the second device may also project a representation of the second digital object. In this example, the spatial relationship between the first digital object and the second digital object may be preserved. The spatial relationship may be preserved by projecting the representation of the second digital object into the second physical space at a location relative to the location at which the representation of the first digital object is projected, where these locations correspond to relative locations of the first digital object and the second digital object in the virtual space. In another example, the second artifact from which the second digital object is associated may exist within the second space. In this case, the representation of the first digital object may be projected relative to the artifact in a manner that corresponds to the relative locations of the first digital object and the second digital object in the virtual space.

Method 300 also includes controlling the first device to project a representation of a second artifact from the second physical space at 360. The first device may project the representation of the second artifact into the first physical space. The representation of the second artifact may be projected into the first physical space based on the calibration of the first physical space to the virtual space. The representation may also be projected based on the calibration of the second physical space to the virtual space. As mentioned above, the projection of the representation of the second artifact may preserve relative spatial relationships between objects in different spaces. This may facilitate synchronous communication between different spaces of different sizes in a manner that facilitates preserving both explicit content of artifacts and spatial relationships between artifacts in different physical spaces.

Method 300 also includes capturing a manipulation of the first artifact at 370. Method 300 also includes associating the manipulation of the first artifact with the first digital object at 380. Method 300 also includes controlling the second device to project a representation of the manipulation of the first artifact at 390. The representation of the manipulation of the first artifact may be projected into the second physical space. By capturing manipulations of artifacts, changes to the state of one physical space may be sent to and projected into other physical spaces, facilitating synchronous communication between multiple physical spaces.

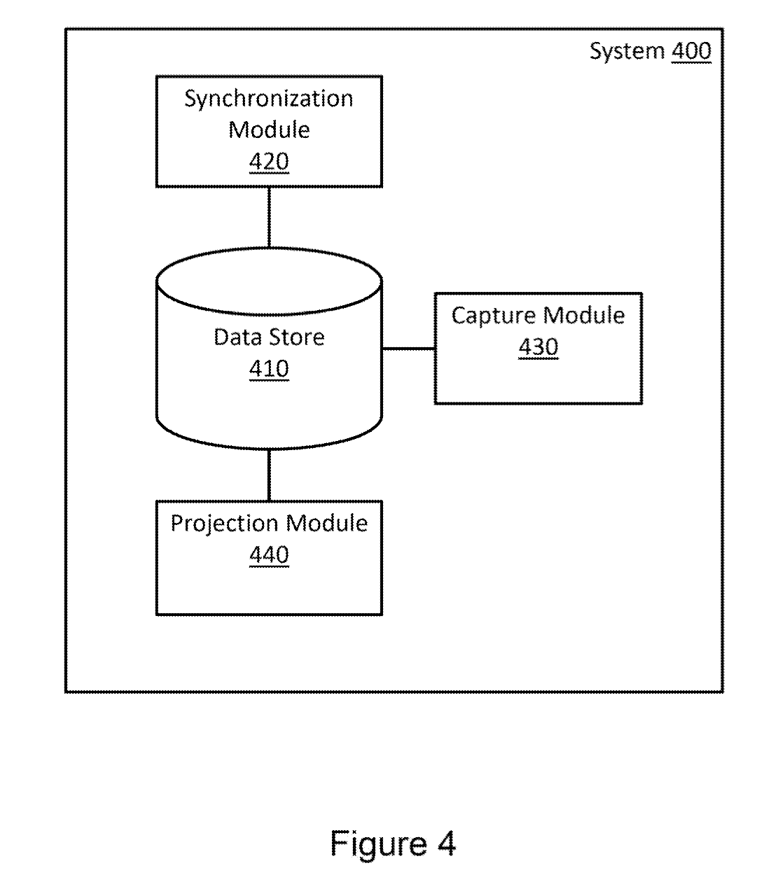

FIG. 4 illustrates a system 400. System 400 includes a data store 410. Data store 410 may store a virtual space. System 400 also includes a synchronization module 420. Synchronization module 420 may control a first device to calibrate a first physical space to the virtual space. Synchronization module 420 may also control a second device to calibrate a second space to the virtual space. In some examples, the second space may be a physical space. In other examples, the second space may be electronically displayed on the second device. In various examples, system 400 may reside in the first device, the second device, a remote server, and so forth.

System 400 also includes a capture module 430. Capture module 430 may store digital objects in the virtual space in response to a signal received from the first device. The signal may describe artifacts in the first physical space. Digital objects may be assigned digital locations in the virtual space that correspond to physical locations of respective artifacts in the first physical space.

System 400 also includes a projection module 440. Projection module may 440 control the second device to project representations of digital objects into the second space. The representations of digital objects may be projected at locations in the second space that correspond to respective digital locations of the digital objects. In some cases, projection module 440 may control selective distortion of representations of digital objects. Distorting representations of digital objects may facilitate preserving spatial relationships between digital objects. Distorting representations of digital objects may also ensure appropriate sizing of representations projected into physical spaces having differing attributes.

In examples where the second space is a physical space, capture module 430 may also store digital objects in the virtual space in response to signals received from the second device. The signals received from the second device may describe artifacts in the second space. In these examples, projection module 440 may also control the first device to project representations of digital objects into the first physical space. The representations of digital objects projected into the first physical space may be of digital objects associated with artifacts from the second space. Consequently, the combination of projection module 430 and projection module 440 may facilitate synchronous communication between the first physical space and the second physical space.

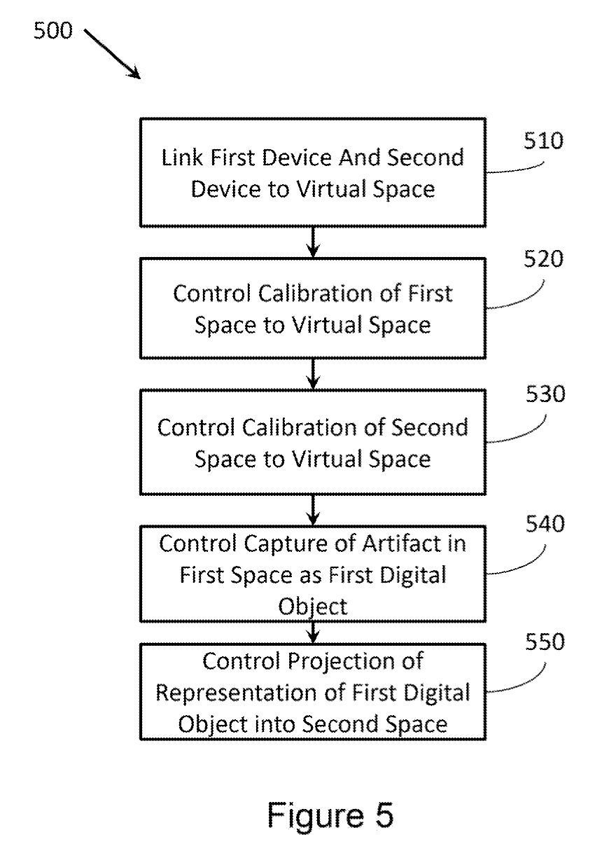

FIG. 5 illustrates a method 500. Method 500 includes linking a first device and a second device to a virtual space at 510. The first device may be in a first physical space and the second device may be in a second physical space. Linking the devices to the virtual space may cause data to be sent to the devices, allowing the devices to load data regarding the virtual space and calibrate physical spaces in which the devices reside to the virtual space.

Method 500 also includes controlling the first device to calibrate the first physical space to the virtual space at 520. Method 500 also includes controlling the second device to calibrate the second physical space to the virtual space at 530. Calibrating the devices may include orienting attributes of the physical spaces to attributes of the virtual space. This may facilitate capturing artifacts as digital objects from a physical space to a corresponding location in the virtual space, as well as projecting representations of digital artifacts from the virtual space to corresponding locations in the physical space.

Method 500 also include controlling the first device to capture an artifact in the first physical space at 540. The first artifact may be captured as a first digital object in the virtual space. Method 500 also includes controlling the second device to project a representation of the first digital object at 550. The representation of the first digital object may be projected into the second physical space. The representation of the second physical space may be projected at a location in the second physical space based on the orientation of the first physical space to the virtual space and on the orientation of the second physical space to the virtual space.

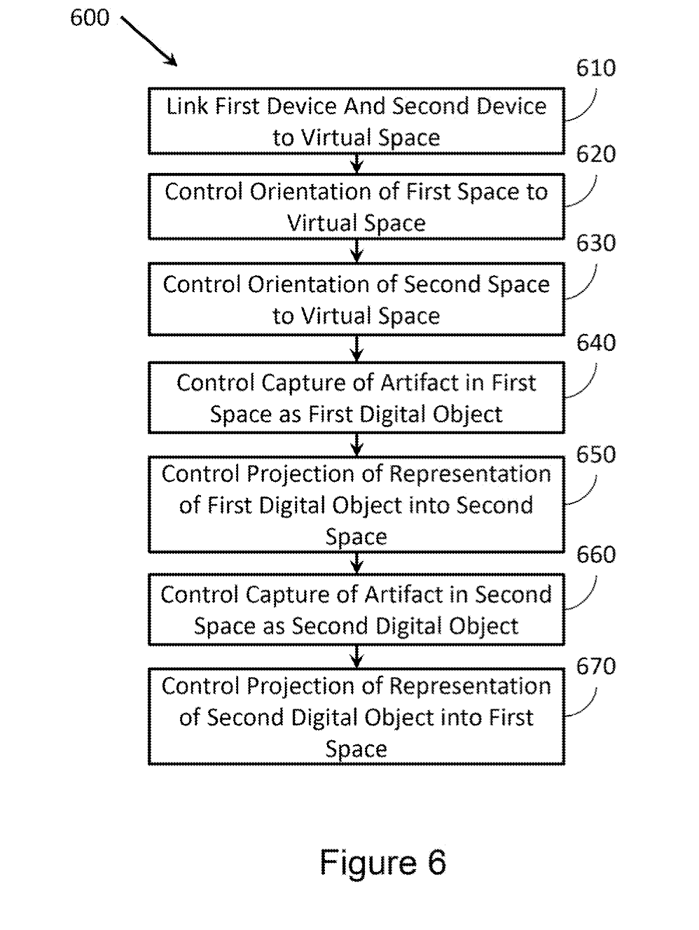

FIG. 6 illustrates a method 600 associated with virtual space calibration. Method 600 includes several actions similar to those described above with reference to method 500 (FIG. 5). For example, method 600 includes linking a first device and a second device to a virtual space at 610, controlling calibration of a first space to a virtual space at 620, controlling calibration of a second space to the virtual space at 630, controlling capture of an artifact in the first space at 640, and controlling projection of a first digital object at 650.

Method 600 also includes controlling the second device to capture an artifact in the second physical space at 660. This artifact may be captured as a second digital object in the virtual space. Method 600 also includes controlling the first device to project a representation of the second digital object at 670. The second digital object may be projected into the first physical space. The second digital object may be projected at a location in the first physical space based on the orientation of the first physical space to the virtual space and on the orientation of the second physical space to the virtual space. In various examples, the projection of the representation of the first digital object and the projection of the representation of the second digital object may occur simultaneously.

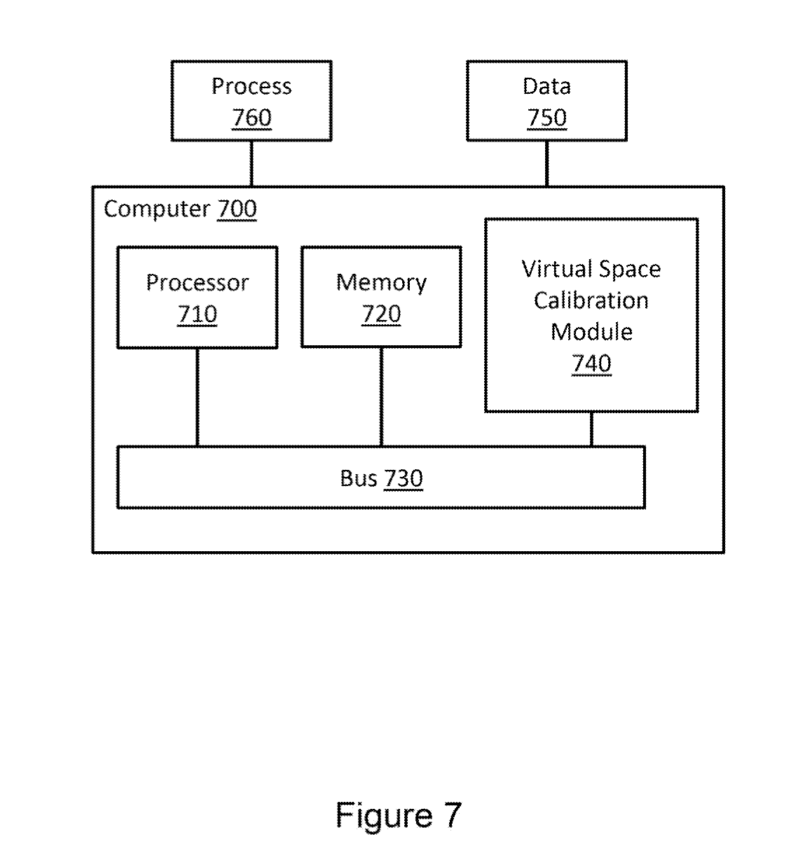

FIG. 7 illustrates an example computing device in which example systems and methods, and equivalents, may operate. The example computing device may be a computer 700 that includes a processor 710 and a memory 720 connected by a bus 730. The computer 700 includes a virtual space calibration module 740. Virtual space calibration module 740 may, perform the function of various systems, methods, and equivalents described above. In different examples, virtual space calibration module 740 may be implemented as a non-transitory computer-readable medium storing computer-executable instructions, in hardware, software, firmware, an application specific integrated circuit, and/or combinations thereof.

The instructions may also be presented to computer 700 as data 750 and/or process 760 that are temporarily stored in memory 720 and then executed by processor 710. The processor 710 may be a variety of various processors including dual microprocessor and other multi-processor architectures. Memory 720 may include non-volatile memory (e.g., read only memory) and/or volatile memory (e.g., random access memory). Memory 720 may also be, for example, a magnetic disk drive, a solid state disk drive, a floppy disk drive, a tape drive, a flash memory card, an optical disk, and so on. Thus, memory 720 may store process 760 and/or data 750. Computer 700 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising,
calibrating a first physical space to a virtual space in response to a first signal received from a first device in the first physical space;
calibrating a second physical space to the virtual space in response to a second signal received from a second device in the second physical space;
controlling the second device to project, into the second physical space, a representation of a first artifact from the first physical space;
where the representation of the first artifact is projected into the second physical space based on the calibration of the first physical space to the virtual space and based on the calibration of the second physical space to the virtual space.

2. The method of claim 1, comprising controlling the first device to project, into the first physical space, a representation of a second artifact from the second physical space, where the representation of the second artifact is projected into the first physical space based on the calibration of the first physical space to the virtual space and on the calibration of the second physical space to the virtual space.

3. The method of claim 1, comprising storing a first digital object associated with the first artifact in the virtual space, where the representation of the first artifact projected into the second physical space is generated based on the first digital object.

4. The method of claim 3, comprising storing, in the virtual space, a second digital object associated with a second artifact, where storing the second digital object establishes a spatial relationship between the first digital object and the second digital object in the virtual space, and where the second device projects the representation of the first artifact into the second physical space in a manner that preserves the spatial relationship.

5. The method of claim 1, comprising
capturing a manipulation of the first artifact;
associating the manipulation of the first artifact with the first digital object; and
controlling the second device to project, into the second physical space, a representation of the manipulation of the first artifact.

6. The method of claim 1, where the first artifact is distinguished from other artifacts in the first physical space using at least one of, seam carving techniques, chrome key techniques, safety box techniques, and outline projection techniques.

7. The method of claim 1, where the first signal and the second signal are received by a server remote to the first device and remote to the second device, and where the server controls the second device to project the representation of the first artifact.

8. The method of claim 1, where the first signal and the second signal are received by the first device and where the first device controls the second device to project the representation of the first artifact.

9. A system, comprising:
a data store to store a virtual space;
a synchronization module to control calibration of a first physical space to the virtual space by a first device and to control calibration of a second space to the virtual space by a second device;
a capture module to store digital objects in the virtual space in response to a signal received from the first device describing artifacts in the first physical space, where the digital objects are assigned digital locations in the virtual space that correspond to physical locations of the artifacts in the first physical space; and
a projection module to control the second device to project representations of the digital objects into the second space, at locations in the second space that correspond to respective digital locations of the digital objects.

10. The system of claim 9, where the second space is a physical space, where the capture module also stores digital objects in the virtual space in response to a signal received from the second device describing artifacts in the second space, and where the projection module controls the first device to project representations of digital objects into the first physical space.

11. The system of claim 9, where the projection module controls selective distortion of representations digital objects to preserve spatial relationships between digital objects and to ensure appropriate sizing of representations projected into physical spaces having differing attributes.

12. The system of claim 9, where the second space is electronically displayed on the second device.

13. A method, comprising:
linking a first device and a second device to a virtual space, where the first device is in a first physical space and the second device is in a second physical space;
controlling the first device to calibrate the first physical space to the virtual space;
controlling the second device to calibrate the second physical space to the virtual space;
controlling the first device to capture an artifact in the first physical space as a first digital object in the virtual space; and
controlling the second device to project a representation of the first digital object into the second physical space, at a location in the second physical space based on the orientation of the first physical space to the virtual space and on the orientation of the second physical space to the virtual space.

14. The method of claim 13, comprising:
controlling the second device to capture an artifact in the second physical space as a second digital object in the virtual space; and
controlling the first device to project a representation of the second digital object into the first physical space, at a location in the first physical space based on the orientation of the first physical space to the virtual space and the orientation of the second physical space to the virtual space.

15. The method of claim 14, where the projection of the representation of the first digital object and the projection of the representation of the second digital object occur simultaneously.
